(19) United States
(12) Patent Application Publication
(10) Pub. No.: US 2005/0240857 A1
(43) Pub. Date: Oct. 27, 2005

(54) Methods and systems of information portal construction

(76) Inventors: Jason Benedict, Cambridge, MA (US); Christopher Reynolds, Revere, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/098,776

(22) Filed: Apr. 4, 2005

Related U.S. Application Data
(60) Provisional application No. 60/559,268, filed on Apr. 2, 2004.

(51) Int. Cl. G06F 17/00

(52) U.S. Cl. 715/500

(57) ABSTRACT

Methods and systems are provided for web site construction, including method and system for using page modules for facilitating web site construction without requiring the user to have specialized knowledge of web site coding techniques.

### RELATED APPLICATIONS

This application claims the benefit of U.S. Prov. App. No. 60/559,268, filed Apr. 2, 2004 and entitled Methods and Systems of Informational Portal Construction.” The disclosure of that application is incorporated herein by reference in its entirety.

### BACKGROUND

1. Field

This invention relates to the field of information technology, and more particularly to methods and systems of information portal construction and modification.

2. Description of Related Art

Website construction is difficult and generally requires technicians with training and specific skills. As a result of these difficulties, those in need of a website often refer the task of its construction or modification to specialized consultants. There is a need for tools assisting website construction and alteration to make the process more efficient and intuitive.

### SUMMARY

The present invention relates to improved methods and systems for the construction of information sites (e.g. websites). In embodiments, the websites reside on an intranet, extranet, internet, or local network. In embodiments, the process for generating a website according to the principles of the present invention are more intuitive than conventional methods. Methods and systems of generating a website through the use of page modules are described herein. The present invention also relates to network searching techniques. The inventions are more fully described herein.

In an embodiment, solutions are provided that are collections of packages that may be sold together to provide users with the tools they need to build a site themselves. For example, a real estate solution contains various packages similar to that offered on a host website, such as a website core, a real estate manager, an image and document manager, and a calendar with an address book.

In an embodiment, packages are collections of specialized page modules installed with a solution to perform a specific function. For example, a Real Estate Manager has page modules that help real estate agents add their property listings to a database and allow visitors to search and view each listing. In an embodiment, packages can also work in conjunction to enhance each other's features. For instance, the Real Estate Manager works with the Image and Document Manager to allow agents to upload photos and movies of their properties for sale and rent.

In an embodiment, page modules are provided that include specialized forms and templates that perform the majority of functions within the website, from helping a user input information to arranging that information on a page.

In an embodiment, page items are provided as page modules specialized to help a user add and arrange different types of content to a webpage. For example, the “Text and Image Paragraph” helps Users arrange text next to an image to form a paragraph for adding to a Page. Other examples of page items include a calendar, memo pad, task pad, journal, calculator, image editor, word editor, presentation editor, database, database description, facility description, short-cut to another page, location or file, spreadsheet, mail facility, instant messenger facility, webmail facility, or other facility desired by a user or creator of a page.

In an embodiment, a “skin” (e.g. a programmed graphic or audio effect) is provided as a facility in a web site construction kit. For example, page modules, page items, and other graphical representations can be inserted into, or associated with, a graphical skin for additional visual style. In an embodiment, a skin may be a preprogrammed function.

In an embodiment, site areas are used to help arrange website information into organized structures. For example, site areas can have “parent” and “child” relationships with other site areas and pages to create a dynamic website structure that can be rearranged with a User's direction using the BeYourOwn.net platform. In an embodiment, security options are included with each site area to govern precisely which users have access to view/edit that site area and the “child” areas and pages within it.

In an embodiment, pages are website documents “within” Site Areas that hold Page Modules to either help a user add/edit information, or display it. In an embodiment, security options may also be included with each page to govern precisely which users have access to view/edit it or otherwise manipulate the page or information associated with the page. In an embodiment, a page may be a computer generated graphical representation of information.

In an embodiment, a user is any person connected to a website or other information system. A user may be an operator, generator, creator, or other person or entity using an information system according to the principles of the present invention. In an embodiment, a user may be running the BeYourOwn.net platform. For example, when a user connects to a BeYourOwn.net website they are identified and assigned a “permission” that dictates which site areas and pages they can view and edit. When a person initially connects to a site, they may be assigned the permission “guest” until they login to the site with a user account.

In an embodiment, permissions are assigned to users, and each site area and page within a site has options to determine which user permissions are allowed to view and edit them.

Particular references are made to websites and webpages herein. These are specific examples of computer facilities that contain information that may be obtained through a computer network. Other information portals are envisioned by the inventors and are encompassed by the present invention.

An embodiment of the present invention is a web page construction method and system. The method and system comprise the steps of providing a page item template via a server computer facility, accessing the page item template via a client computer facility, building a page item using the page item template via the client computer facility, and saving the page item to a web page.

The web page construction method and system provide a page item template comprised of text with an image template. In embodiments, the page item template comprises a text editor. In embodiments, the page item template comprises a standard word processing facility. In embodiments, the page item template comprises a standard word processing facility wherein the standard word processing facility is Microsoft® Internet Explorer. In embodiments, the page item template includes a calendar facility, calculator facility, text editor, image facility, link facility, hyperlink facility, spreadsheet facility, or a presentation facility. In embodiments, the page item template includes a skin application facility.

An embodiment of the present invention is a web page construction method and system. The method and system provide an add page item page via a server computer facility, access the add page item page via a client computer facility, and construct a web page using the add page item page. In embodiments, the add page item page includes provisions for selecting one of a plurality of page item templates. In embodiments, one of the plurality of page item templates includes a text editor. In embodiments, at least one of the plurality of page item templates includes a multi-column text editor. In embodiments, at least one of the plurality of page item templates includes a text editor with an image facility. In embodiments, at least one of the plurality of page item templates includes a movie facility. In embodiments, the add page item page includes provisions for adding at least one skin to a portion of the web page under construction.

An embodiment of the present invention is a method and system for constructing a website. The method and system provide a page item template on a computer facility, access the page item template through the computer facility, build a page item using the page item template using the computer facility, and save the page item to a web page. In embodiments, the page item template comprises a text with image template. In embodiments, the page item template comprises a text editor. In embodiments, the text editor uses a standard word processing facility. In embodiments, the standard word processing facility is Microsoft® Internet Explorer. In embodiments, the page item template includes at least one of a calendar facility, calculator facility, text editor, image facility, link facility, hyperlink facility, spreadsheet facility, or presentation facility. In embodiments, the page item template includes a skin application facility.

An embodiment of the present invention is a web page construction method and system. The method and system provide an add page item page through a computer facility, access the add page item page through the computer facility, and construct a web page using the add page item page. In embodiments, the add page item page includes provisions for selecting one of a plurality of page item templates. In embodiments, at least one of the plurality of page item templates includes a text editor. In embodiments, at least one of the plurality of page item templates includes a multi-column text editor. In embodiments, at least one of the plurality of page item templates includes a text editor with an image facility. In embodiments, at least one of the plurality of page item templates includes a movie facility. In embodiments, the add page item page includes provisions for adding at least one skin to a portion of the web page under construction. In embodiments, the method and system further provide for a site area and page-choosing facility wherein a user uses the site choosing facility to choose the location to add the page item.

An embodiment of the present invention is a method and system of searching a website. The method and system provide a user with a permission comprised of granted access identifiers, assign a page item a list of required access identifiers and permitted users, have the user search for page items or portions thereof, find a matching page item, and compare the page item permitted user list to the user himself, and the page item access identifier list to the access identifier list corresponding to the user's permission. In embodiments, the user is in the page item permitted user list or each item in the page item access identifier list is present in the access identifier list corresponding to the user's permission and the page item is exposed to the user. In embodiments, the entire page item is exposed to the user. In embodiments, not all entries in the page item access identifier list are present in the access identifier list corresponding to the user's permission and the user is not in the page item permitted user list and the page item is not exposed to the user.

An embodiment of the present invention is a method and system of searching a website. The method and system provide a user with a first permission, assign a plurality of page items a respective permissions, have the user search for page items or portions thereof, find a plurality matching page item, and compare the first permission to the respective matching page item permissions. In embodiments, the method and system further comprise the steps of: exposing a plurality of page items to the user where the first permission matches the respective page item permissions. In embodiments, the plurality of exposed page items are exposed on the same page. In embodiments, the method and system further comprise: causing the page of exposed page items to be saved. In embodiments, the step of causing the page of exposed page items to be saved includes a step of selecting at least one of selecting a new page to be saved and selecting a page area where the results are to be saved.

An embodiment of the present invention is a method and system of constructing a web page. The method and system execute a web services command from a portable web enabled device, cause another device to receive the web services command and to return a page item construction template to the portable web enabled device. In embodiments, the method and system further comprise the steps of completing the page item construction template, and saving the completed page item to a web page.

An embodiment of the present invention is a method and system of developing a web page. The method and system obtain a web page building template from a server facility, and use the web page building template to generate at least a portion of a web page. In embodiments, the method and system further comprise the step of saving the at least a portion of a web page to an existing web page. In embodiments, the method and system further comprise the step of saving at least a portion of a web page as a new web page. In embodiments, the method and system present the template as a graphical representation on a computational facility. In embodiments of the method and system the graphical representation includes user selectable features. In embodiments the step of saving a portion of a web page to an existing web page further includes selecting the existing web page from a page chooser. In embodiments, the page chooser is graphically presented to the user. In embodiments, the presentation is in a selectable menu format.

It should be appreciated that all combinations of the foregoing concepts and additional concepts discussed in greater detail below are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

FIG. 1 illustrates a webpage construction template according to the principles of the present invention.

FIG. 2 represents an add-item-to-page facility according to the principles of the present invention.

FIG. 3 represents an edit page item page according to the principles of the present invention.

FIG. 4 illustrates a finished page item page according to the principles of the present invention.

FIG. 5 illustrates two views of a finished web page according to the principles of the present invention.

FIG. 6 illustrates a copy page item page according to the principles of the present invention.

FIG. 7 illustrates a site area and page selector page according to the principles of the present invention.

FIG. 8 illustrates some exemplary functions that may be performed according to the principles of the present invention.

FIG. 9 illustrates a copy process flow according to the principles of the present invention.

FIG. 10 illustrates a search process flow according to the principles of the present invention.

FIG. 11 illustrates a search process flow according to the principles of the present invention, wherein only certain matching modules are presented in the results page due to lack of permission.

FIG. 12 illustrates a search results page according to the principles of the present invention.

FIG. 13 illustrates a save results page according to the principles of the present invention.

FIG. 14 illustrates a client server network relationship according to the principles of the present invention.

FIG. 15 illustrates a business process for generating a website according to the principles of the present invention.

FIG. 16 illustrates a method and system of developing a website or other information portal locally according to the principles of the present invention.

FIG. 17 illustrates a method and system of developing a website or other information portal locally with server interactions according to the principles of the present invention.

FIG. 18 represents a method and system of developing a website or other information portal locally with server interactions according to the principles of the present invention.

FIG. 19 illustrates an information portal construction facility deployed through XML web services according to the principles of the present invention.

FIG. 20 illustrates a method and system of constructing a website or other information portal through the use of a portable computing device and web services according to the principles of the present invention.

### DETAILED DESCRIPTION

The structure and operation of various methods and systems that are embodiments of the present invention will now be described. It should be understood that many other ways of practicing the invention herein are available, and the embodiments described herein are exemplary and not limiting.

An aspect of the present invention relates to the method and system for the construction of a computer accessible information site (e.g. website, webpage, intranet site). An embodiment of the present invention provides a method for the construction of a computer accessible information site through the use of a graphical user interface to provide ease of use. The graphical user interface may be provided to permit a user that is otherwise unfamiliar with the techniques used to construct an information site with intuitive tools such that he can quickly build a useful site. For example, a website construct kit may be made available to a user wherein the construction site includes a computer driven user interface that includes page build wizards and page modules that make assembly of the information page more intuitive. The page modules may be specialized forms and or templates that perform functions within an information site. The page modules may also include security features that can be used during, or after, construction of the site to enable certain users to access certain sections or modules while preventing other users such access. The construction kit may also include skins (e.g. pre-programmed graphical representations) wherein the skins are used to add visual effects to the information site or a section or module within the site.

In an embodiment, a web construction kit is provided to a user. The construction kit may include page modules, page items, skins, and other site construction tools. The kit may also generate a computer interface that facilitates the construction of a website through the use of the tools. The interface may include systems for allowing editing, copying, moving, generating, or other facilities to accomplish the task of building a custom website through intuitive methods.

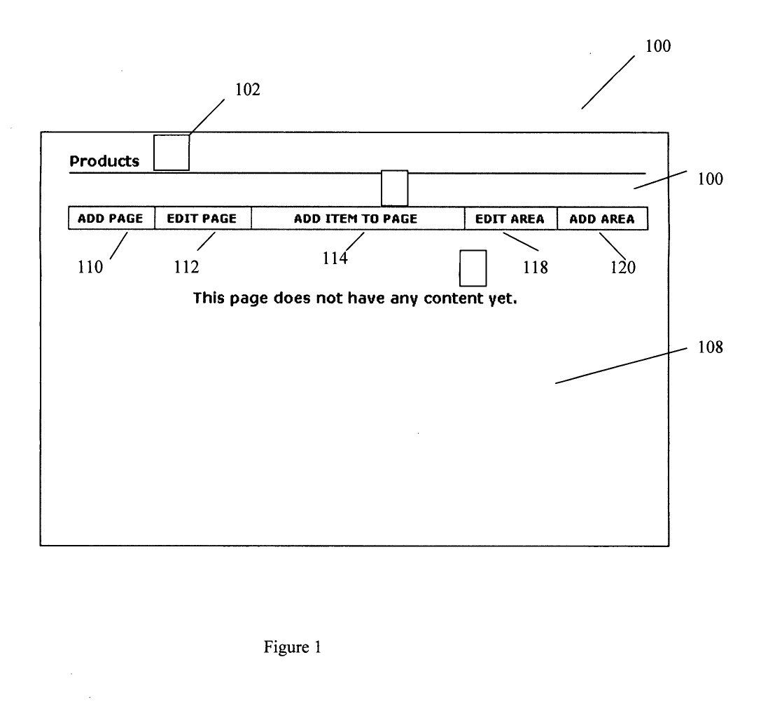

FIG. 1 illustrates a webpage construction template 100 according to the principles of the present invention. The construction template 100 includes a page header area 102, a tool bar 104, and a construction area 108. The construction area 108 may be used to layout the portions of an information site. The tool bar 104 includes tools for adding a page 110, editing a page 112, adding an item to a page 114, editing an area 118, and adding an area 120. In an embodiment, the tool bar provides links to portions of a local program or local libraries (e.g. when the construction program is running locally). In an embodiment, the tool bar provides links to a program and or library running on a server. For example, the construction program may be running from a server application over the World Wide Web and the tool on the tool bar 104 may link to another webpage. In an embodiment, the construction program may be running locally and the tool on the tool bar 104 may link to a program or library in a local computer system or residing on a network (e.g., an intranet or the World Wide Web).

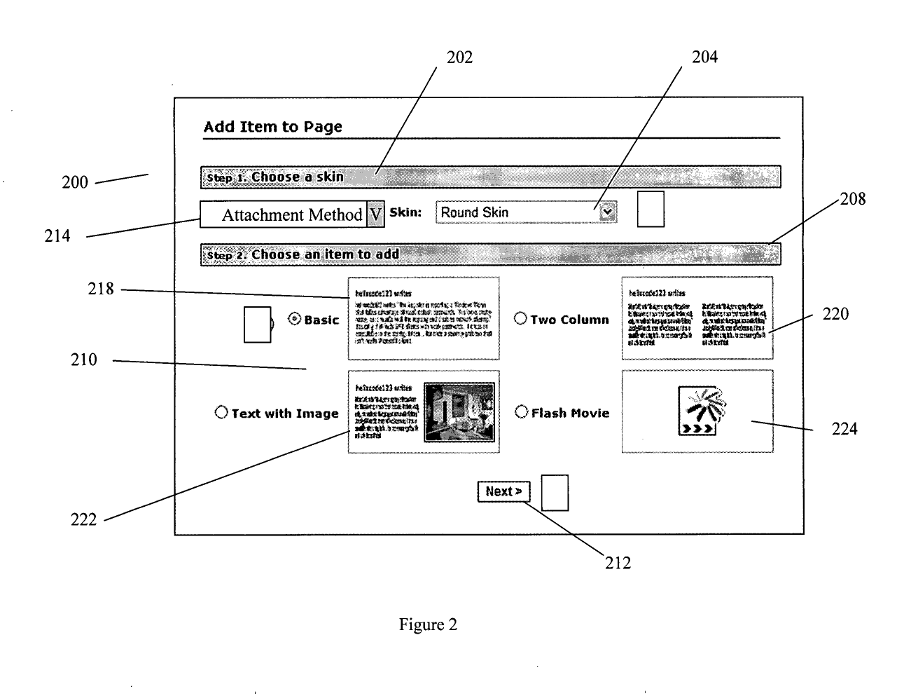

FIG. 2 represents an add item to page facility 200 according to the principles of the present invention. A user may select the add item to page feature 114 from tool bar 104 and then be directed to an add item to page facility 200. The add item facility may include instructions for assisting the user in generating the item he desires. The add item facility 200 includes a step one 202 to choose a skin or graphical template and a step two 208 to choose an item to add. The add item facility may include a drop down menu 204 to permit the user to select a skin or other preprogrammed graphical template or visual themes from the list. In an embodiment, the chosen skin will encase, surround, modify or otherwise be associated with the page item to be added. The drop down skin menu 204 may also include a provision for no skin such that no graphical template is associated with the item to be added. The add item facility also includes a choose item feature 208. Within the choose item feature 208 several page item templates may be provided 210. For example, the templates may include a basic text template 218, a multi-column template 220, a text with image template 222, a flash movie template 224 or any number of other templates used to set the initial format of the item to be added to the page. Once the user has made his selections, he may choose to go to the next phase in the process by choosing the next feature link 212.

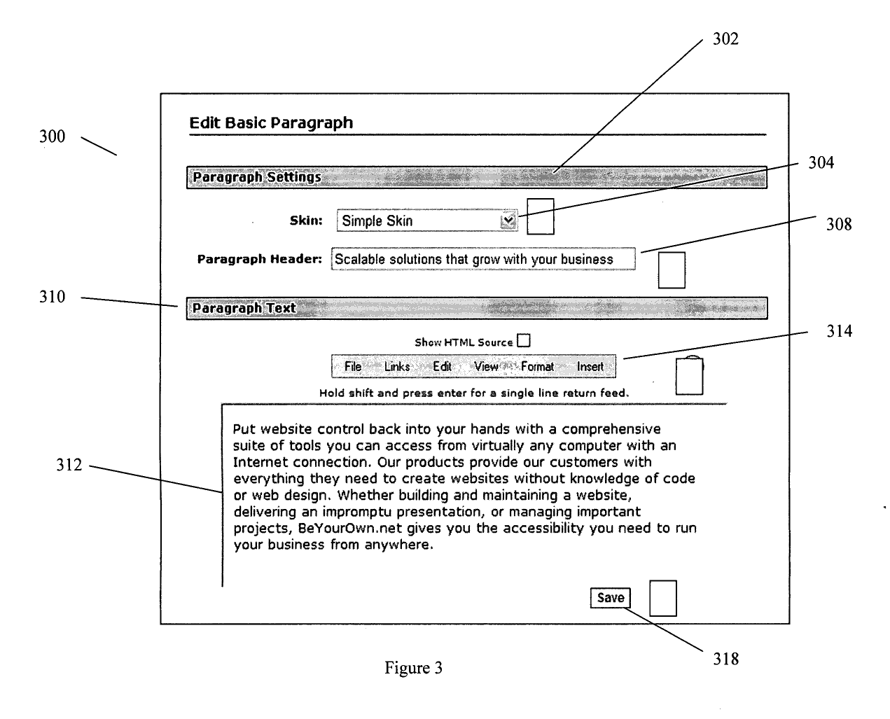

FIG. 3 represents an edit page item page 300 according to the principles of the present invention. A user may select the edit page item from the tool bar 104, as illustrated in FIG. 1 for example. The user may also arrive at the edit page item page following the selection of the next feature link 212. For example, the user may have elected a basic paragraph 218 from the add item page 200. Following the next feature link 212, the user may arrive at the edit basic paragraph page 300. The edit basic paragraph page 300 includes a paragraph setting feature 302. The paragraph setting feature 302 includes a skin selection menu 304 and a paragraph header menu 308. The header menu 308 allows the user to add a header to the paragraph. The skin selection menu 304 may be similar to the skin selection menu 204 by allowing the user to select the skin or graphical effects that are going to be associated with the paragraph or in the paragraph for example. The edit basic paragraph page 300 also includes a paragraph text portion 310 to enable the user to add and or edit text to the paragraph. The user may add and or edit the text in the text box section 312. The features associated with the text box 312 may be supported by another program, Microsoft® Word for example. The text box section 312 may be associated with a tool bar 314. The tool bar may be a custom generated tool bar or it may be associated with another program such as Microsoft® Word. While the text box is generally referred to as a text box, it should be understood that a user may include items other than text in the text box. Similar to a general word processor, the user may select and insert graphics, images, HTML code or other files or links into the text box. Once a user has made the selections and added the desired text, the user may select a save link 318.

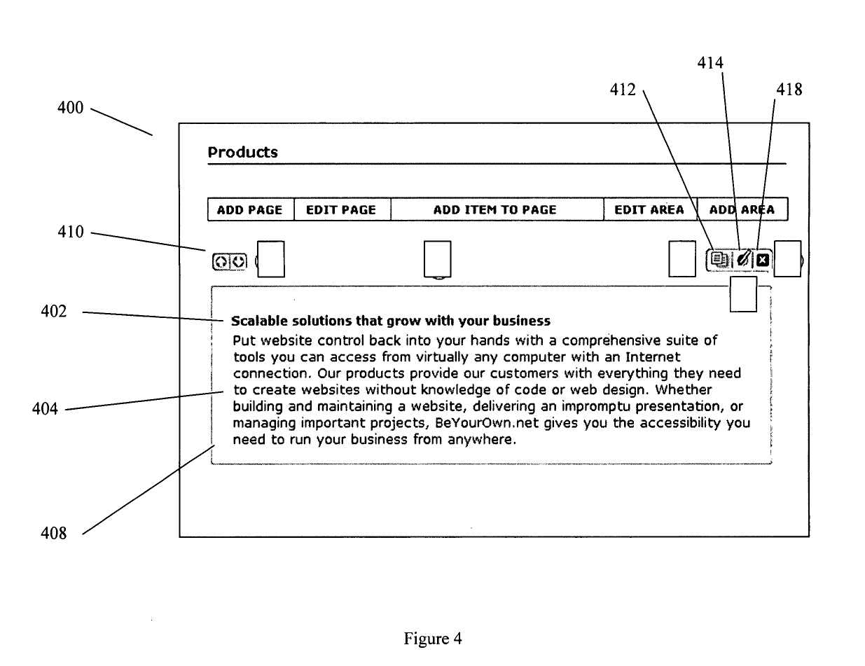

FIG. 4 illustrates a finish page item page 400 according to the principles of the present invention. Following the selection of the save link 318, the user may be connected to the finish page item page 400. The finish page item page 400 includes a finished text box 408 (e.g. representing a page item to be represented on a page). The finished text box 408 includes the header 402, which was previously selected from the edit page 300 and the text 404 that was added in edit page 300, as described above. The finish page item page 400 includes an order feature 410 where a user can select in what order the current page item is listed (e.g., moving a page item above or below other page items on the page). The finish page item 400 includes a copy feature 412 to copy the page item 408 to another page. The finish page item page 400 includes an edit feature 414 to permit the user to edit a portion of the page item. For example, the edit page item may be selected and the program may bring the user to an edit page item page such as in FIG. 3. The finish page item page 400 includes a delete feature 418 that may be used to delete the page item on the page.

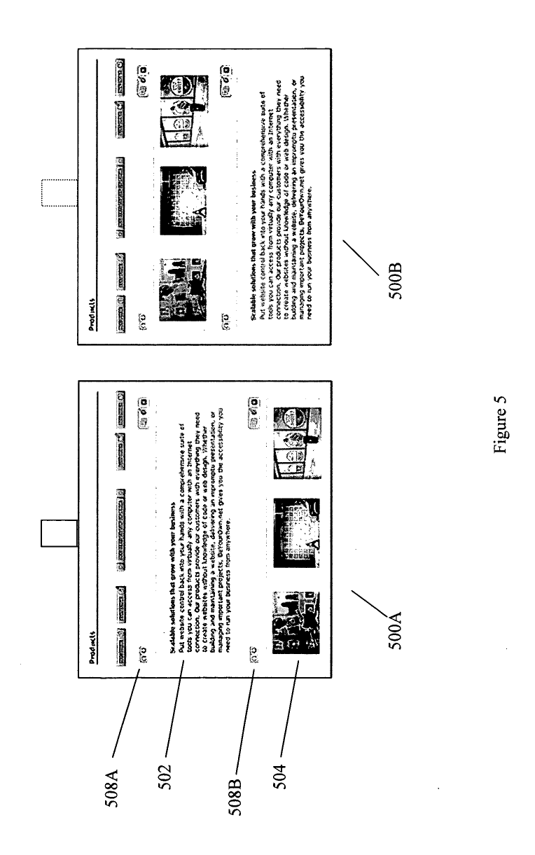

A page may be constructed with several page items and the user may want to alter the relative position of the several page items. FIG. 5 illustrates two views of a finished web page 500 according to the principles of the present invention. The first view 500A illustrates a web page with two page items, a text box 502 and graphics 504. A user may want to move the graphics above the text, rather that have the graphics below as it is illustrated in page 500A. To accomplish this task a user may drag and drop the items or select a move feature 508 that is associated with the page item. In this example, a move feature 508 is associated with each page item, 508A is associated with the text box 502 and 508B is associated with the graphics 504. The move feature 508 includes an up and down feature, similar to order feature 410 in FIG. 4. For example, a user may select the down feature of move feature 508A. The page may then refresh itself and when next displayed, the text box 502 may be moved down below the item directly below text box 502. In this example, this would result in the text box 502 and the graphics 504 switching position and being presented as indicated in page 500B. This is one simple example of how a move feature may be employed, it should be understood that the invention encompasses more complicated move features.

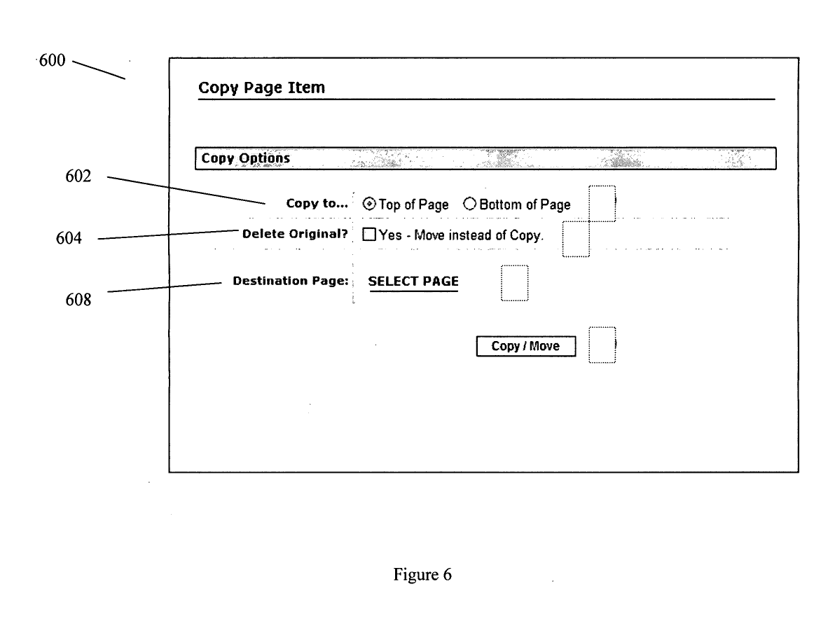

FIG. 6 illustrates a copy page item page 600 according to the principles of the present invention. A user may arrive at the copy page item page 600 following the selection of the copy feature 412 from finish page item page 400 (FIG. 4). The copy page item page has a copy position feature 602 where the user can select the position he would like the copied item to appear on the destination page. The copy page item page 600 also includes a move or copy feature 604 where a user can select whether to keep the copied item in its original location or delete it following the copy command. If the item is deleted, the command is generally referred to as a move command. If the item remains following the copy command, it is generally referred to as a copy command. The copy item page 600 also includes a destination feature 608 where the user can select the desired destination of the copied item. For example, the desired destination may be a particular webpage and the user may designate the webpage as the destination. In an overall example, if the user selects ‘top of page’ from the position feature, ‘move’ from the copy feature and ‘home’ as the destination 608, the item will be moved from its present page location and pasted into the home destination at the top of the home page. It should be understood that this is one method of moving or copying page items from one page to another and there are many other such methods encompassed by the present invention. For example, the page item may be dragged and dropped to another page, or copied and pasted using a menu driven process of another kind.

Another aspect of the present invention provides for systems and methods for locating site areas of a website or other information facility. In an embodiment, a site area and page selector page may be provided to view and choose site areas within a site. In an embodiment, the site locator may appear in a ‘pop-up’ window to allow a user to continue working in the original window while being able to locate and possibly select another location or area in the website or information facility.

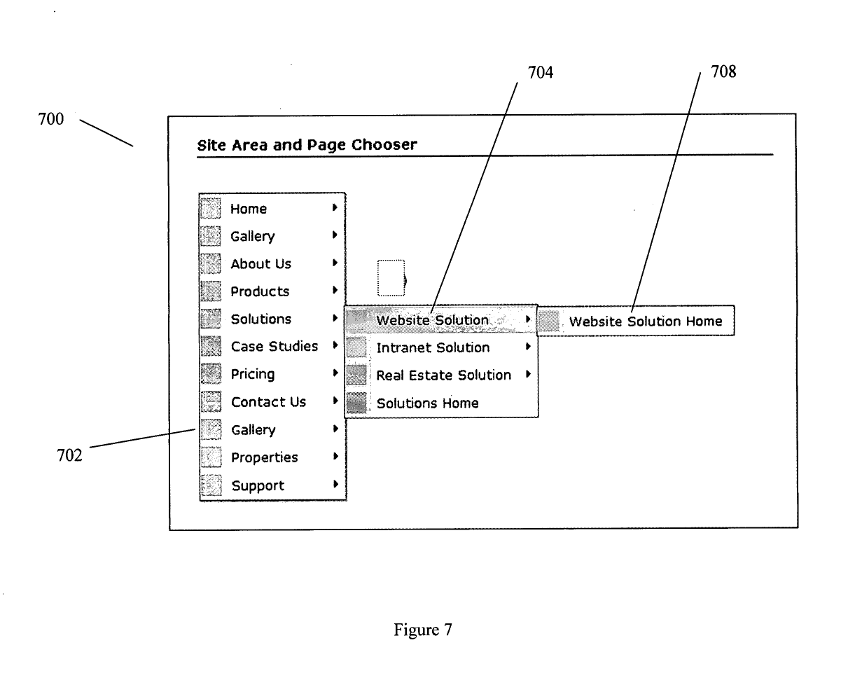

FIG. 7 illustrates a site area and page selector page 700 according to the principles of the present invention. The site area identification page includes a parents list of areas 702 where all of the sites first level areas are listed. In an embodiment, a user may only be permitted to view certain areas and this viewer and selector may only show those certain views. The site area and page selector page 700 also includes a second level area map 704. In this example, the second level areas shown are those associated with the Solutions area listed on the first level (or parents level). These second areas are presented to the user when the user selects the Solutions area (e.g., by dragging a mouse icon to the Solutions area). As with the second level, the page illustrates a third level associated with the Website Solution area. While this is a basic example of how a site map function operates in a method according to the present invention, the present invention encompasses more complex mapping. A user may also select one of the areas within the map and the system may then bring the user to the selected area.

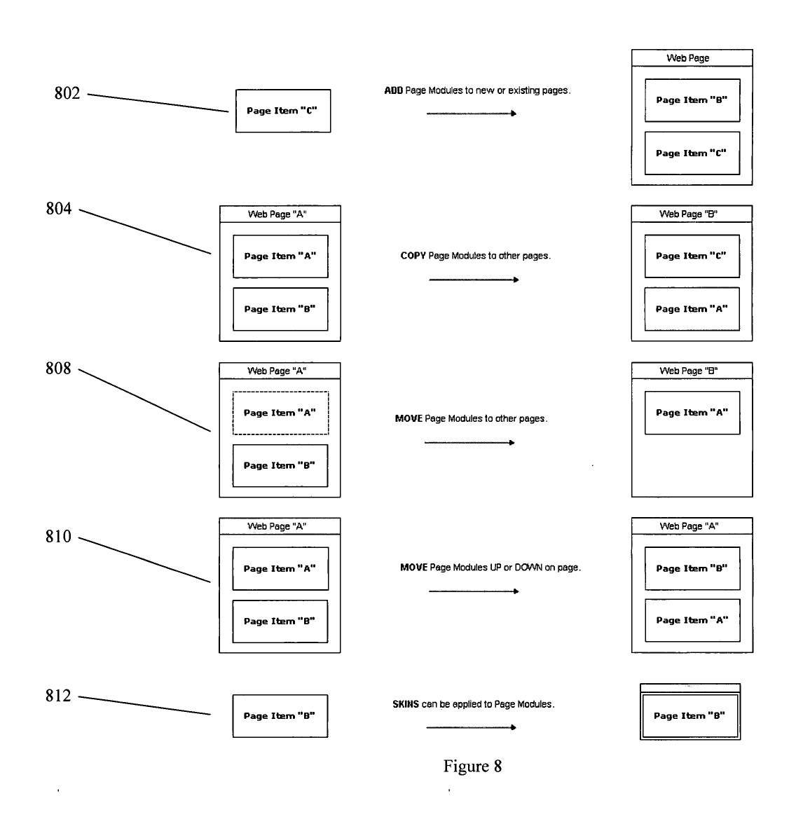

FIG. 8 illustrates some exemplary functions that may be performed according to the principles of the present invention. A page item or module may be added to new or existing pages 802. A page module may be copied to another page 804. A page module may be moved to another page 808. A page module may be moved on a page 810. A skin may be applied to a page module 812.

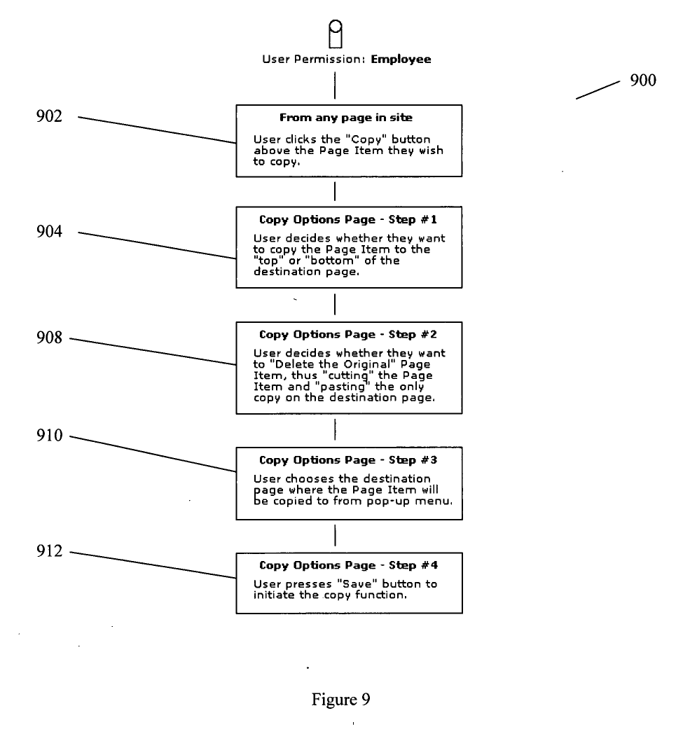

FIG. 9 illustrates a copy process flow 900 according to the principles of the present invention. For example, a user with the appropriate permission (permission and security is discussed in more detail below) may select a copy button above the item they wish to copy from any page in the site 902. It should be understood that there are many methods of copying an item from a page (e.g., selecting from a menu, right clicking a menu) and these methods are encompassed by the present invention. The user may then elect the location of the placement of the copied item or module 904. The user then may decide whether to delete the original copied item, thus cutting the item, or leaving the original copied item, thus copying the item 908. The user may then choose the destination page where the item will be copied to from a pop up menu (e.g., similar to the site area and page selector page 700) 910. The user may then select a save button to initiate the copy function 912.

While many of the functions described herein are illustrated with specific commands, it should be understood that these are simply exemplary and are not intended to limit the invention in anyway. For example, functions such as create, copy, move, delete are illustrated with menu driven methods. It should be understood that these, as well as others described herein, may be accomplished using other menu and non-menu methods. For example, the tasks may be performed using a ‘right click’ menu operation, a key stroke operation (e.g., keys control-c for copy, control-v for paste), voice command, click and drag, touch screen methods, or another method intended to accomplish the desired task.

Another aspect of the present invention relates to the method and system of searching for relevant information in a computer information system. An embodiment of the present invention provides a search facility for searching for portions of the site (e.g., page modules or paragraphs in an internet, extranet, worldwide web or other network facility). For example, once a website has been constructed according to the principles of the present invention, a search engine may be generated and executed to find pages, page items, page modules and the like and save results found.

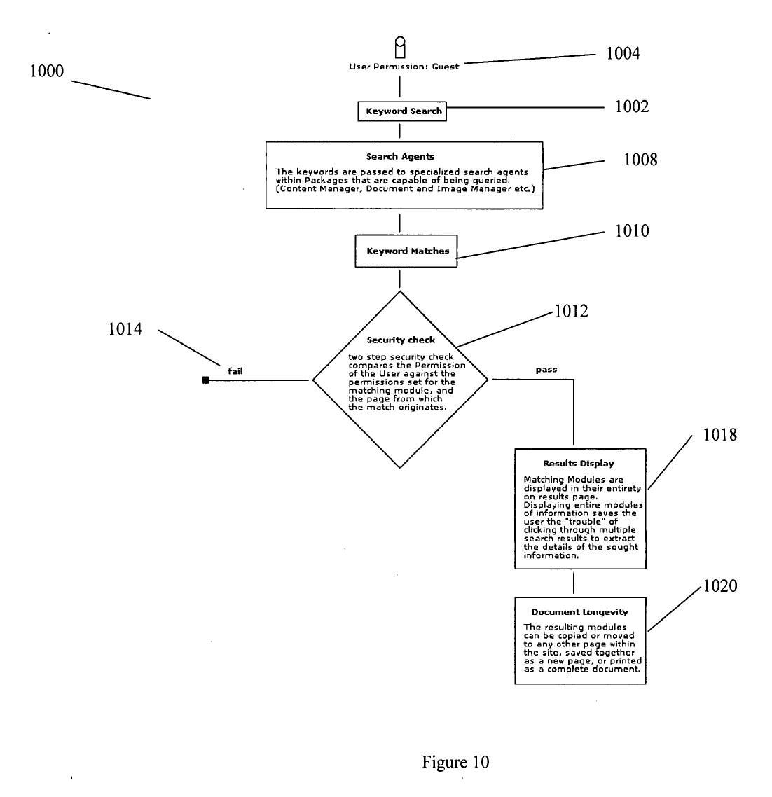

FIG. 10 illustrates a search process flow according to the principles of the present invention 1000. The process flow 1000 includes provisions for checking user identification to ensure security. Only those with appropriate authority can access certain areas in the site. The illustrated process flow 1000 is a keyword search and starts with the entering of key word(s) 1002. The user is identified as a certain type and security level, here Guest 1004. The search criteria, here keywords, are passed to specialized search agents within packages that are capable of being queried (e.g. content manager, document and image manager) 1008. Search criteria matches are identified, keyword matches in this example 1010. A security function is then performed 1012. The security function 1012 has two steps; first a comparison is made between the permission granted to the user and the list of permitted users and required access levels for the matching item or module; and second, a comparison is made between the permission granted to the user and the list of permitted users and required access levels for the page from which the item originated. If either of these comparisons fails, the result is not shown to the user 1014. If both comparisons pass the criteria, the result is displayed 1018 and the result can be saved 1020. When the result is displayed, the matching module may be displayed in its entirety on a results page. Showing the entire module saves the user time by providing all of the relevant material. The resulting module can be copied or moved to another page in the site, or to another site or facility, saved together as a new page, or printed as a complete document 1020.

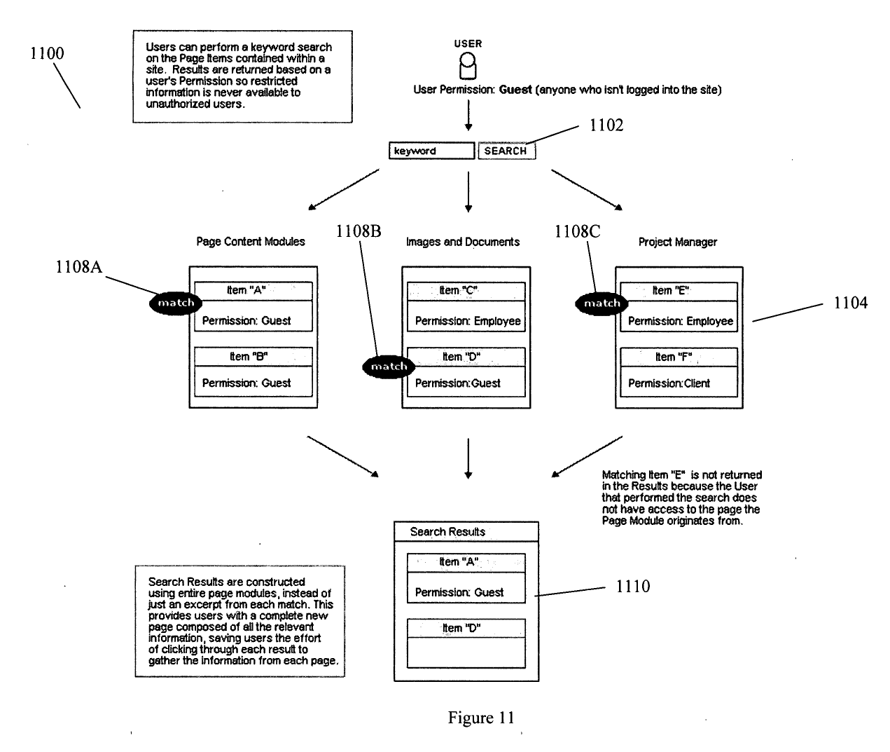

FIG. 11 illustrates a search process flow 1100 according to the principles of the present invention, wherein only certain matching modules are presented in the results page due to lack of permission. This illustration is presented as a keyword search for simplicity of the example and it should be understood, as with other searches described herein, the search process may be adapted for graphics, images, audio files or other content and these are encompassed by the present invention. A keyword is entered by a user 1102 and the search engine searches the website or websites to find matching page items 1104. In this example, three matches are located 1108 A, B and C. The found results are then passed through a permission tree (e.g., as illustrated in accordance with FIG. 10) and matching results with appropriate permission are displayed on a page 1110. Match 1108C matched the search criteria but the user was a guest and therefore could not obtain the result requiring an access identifier of employee. The results page 1110 is constructed using the entire page modules where the search terms were located. In another embodiment, a portion of the module is produced on the results page. The portion is relevant to the search criteria.

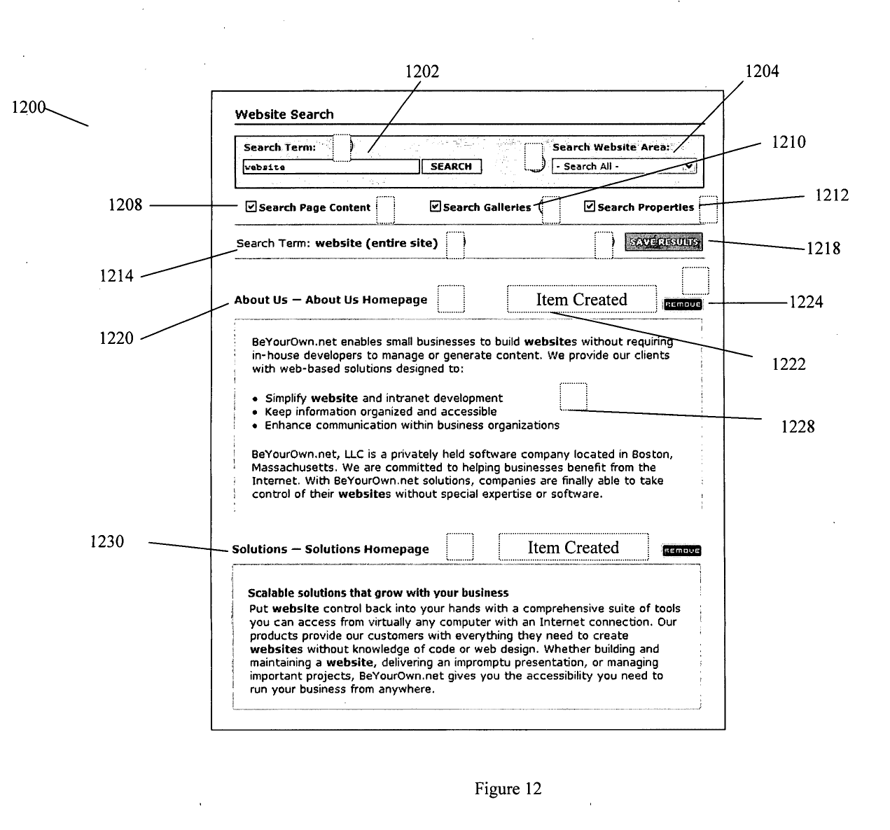

FIG. 12 illustrates a search results page 1200 according to the principles of the present invention. The search results page includes a textbox for users to enter their search term(s) 1202. Users may choose to filter the search by directing the agents to return only results found in a specific Area of the Website 1204. Option to turn the specific search agent for searching Page Content “on” and “off” 1208. Option to turn the specific search agent for searching the Galleries within the Document Manager Package “on” and “off” 1210. Option to turn the specific search agent for searching the Property Listings within the Real Estate Manager Package “on” and “off” 1212. Label highlighting the keyword used in the search and, in parentheses, which Site Areas the search was performed on 1214. The Save Results button lets users save the Page Items on the results page as a new page within the site 1218. A link showing the Site Area and Page Header of the page where the first search result resides 1220. Clicking this link would take the user to that page. Details about the Page Item regarding when it was created, and last updated 1222. Clicking the Remove button removes that Page Item from the results page; it does not affect the original Page Item 1224. The entire Page Item is returned in the results so Users don't have to click to that page in order to extract that information 1228. A link to the page is there in case Users do wish to view the Page Item on its original page. A link showing the Site Area and Page Header of the next search result 1230.

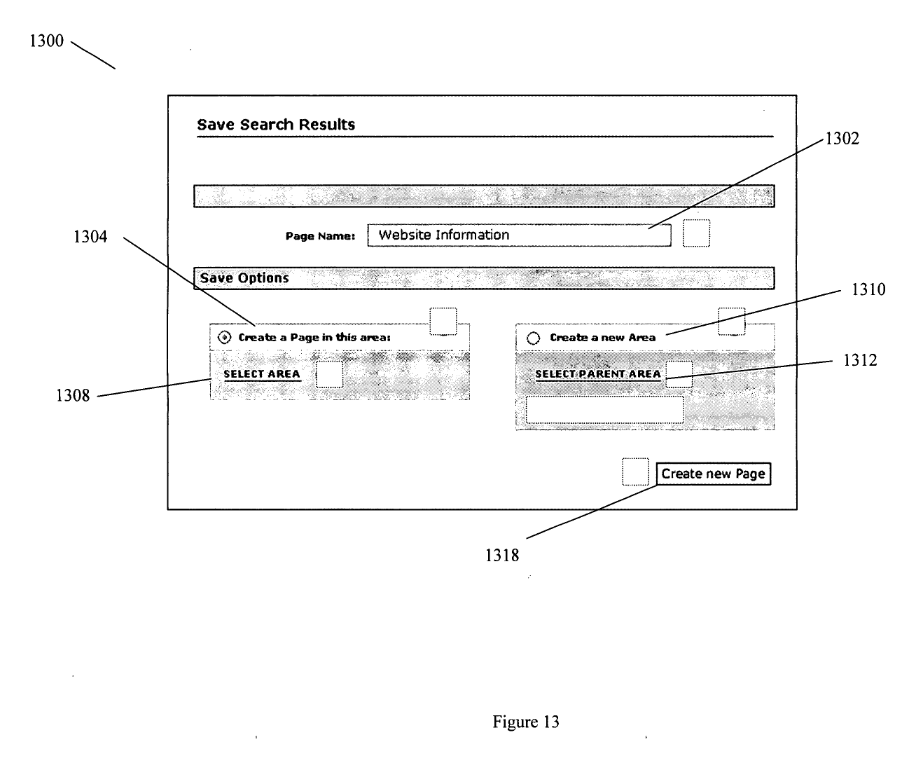

FIG. 13 illustrates a save results page 1300 according to the principles of the present invention. In this example, after a user performs a search and chooses the “Save Results” button (as indicated in connection with item 1218 in the description of FIG. 12), they will be taken to the save search results page to help them specify where and how to create their new page. The save search results page includes a text box for the user to enter a name for the new page (where the results will be saved to) 1302. The user can choose whether they want to create a new site area with a new page for the search results, or simply choose to create a new page within an existing Site Area. If option 1304 is selected, this will make the search results appear on a new page within the site area the user chooses in step 1308. If step 1308 is selected, this link will pop up the area and page selector (previously described in connection with FIG. 7) to help the user specify the area they wish the page to be created in. The other primary option 13 10 for saving search results allows the user to create a new Site Area within the site for the results to be saved to. If step 1312 is selected, this link will pop up the area and page selector to help the user specify a parent site area so a new area will appear under it. Clicking the “Create new Page” button initiates the function 1318 to allow creation of a new page.

Another aspect of the present invention is a system and method for providing assistance to a user in building an information site. In an embodiment, an information site construction kit may be provided in a number of ways. For example, it may be provided through a standalone developer's kit, through a web service site, through a network facility or other system. In an embodiment, a website host may provide pre-programmed page modules, skins, packages, solutions or other services, pre-programmed or otherwise, to be accessed through a computer facility. For example, a user may be permitted certain access to the web host site through a subscription, user license, as a result of employing certain page modules or the like.

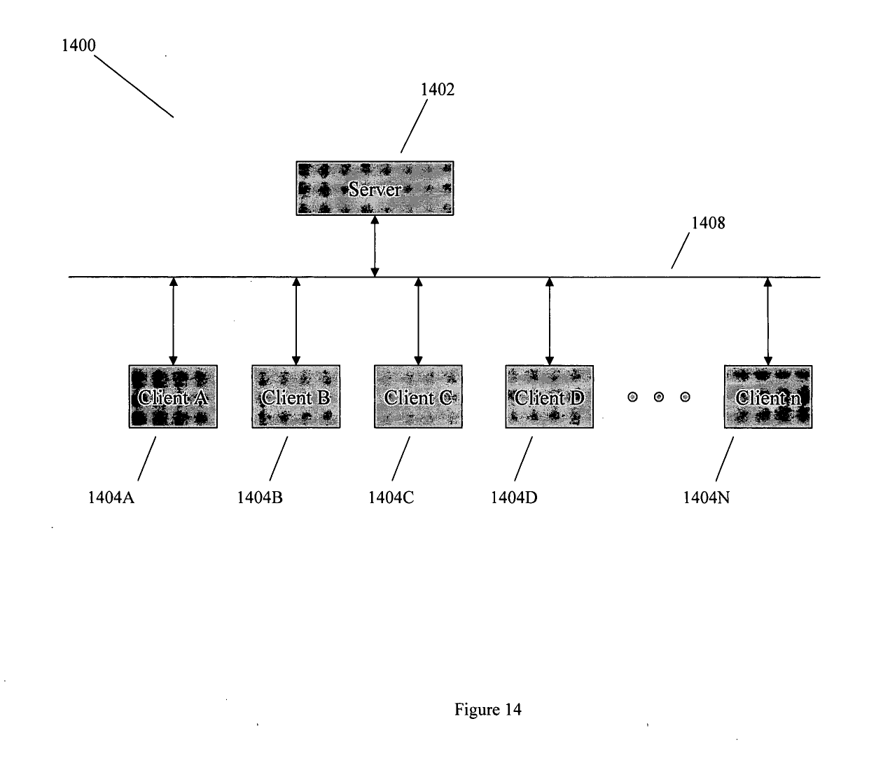

In an embodiment, the services described herein may be provided through a web service (e.g., a construction kit provided through an internet portal). For example, FIG. 14 illustrates a client server network relationship 1400 according to the principles of the present invention. One such web service according to the present invention can be found at www.beyourown.net. The client server network relationship of FIG. 14 illustrates several clients 1404A-N (collectively referred to as 1404) as well as a server 1402. The clients 1404 may communicate with the server 1402 through an intranet, extranet, internet, or other network facility 1408. For example, once a website is created according to the principles of the present invention, it may be deployed in a client server network environment such as the one described in conjunction with FIG. 14.

Another aspect of the present invention relates to the method and system used during the information portal creation process. In an embodiment, the creation process is facilitated through a network using a client server relationship as described in conjunction with FIG. 14. For example, a business may want to build a website (e.g., internet site, intranet site, or extranet site) and the business may communicate with a server program through its locally running web browser program. The server program may offer the construction facility and the method and system of construction as described herein to facilitate the business' website construction project.

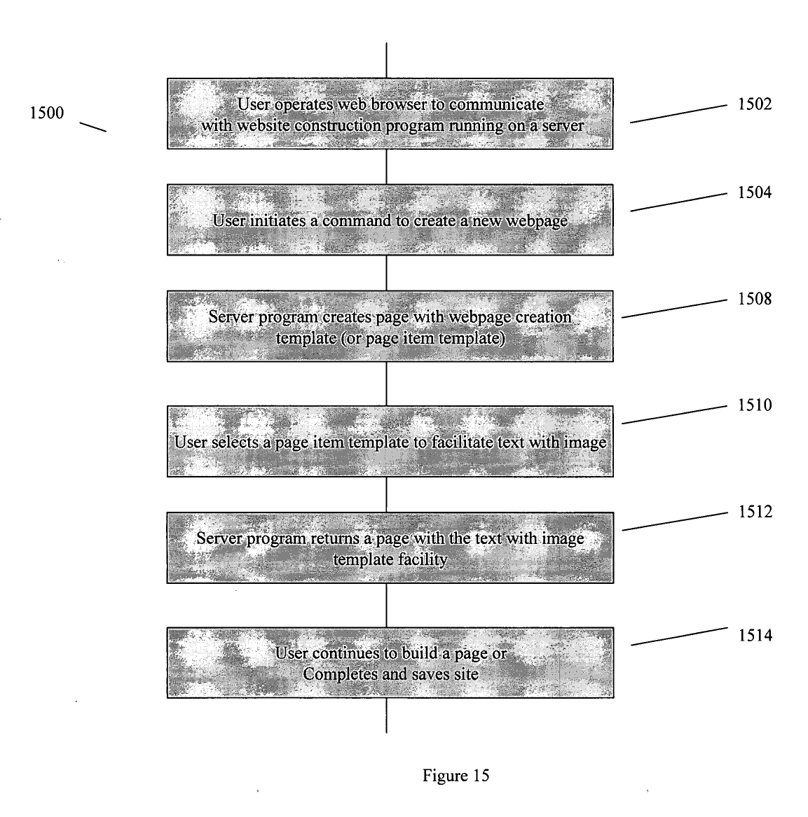

FIG. 15 illustrates a business process for generating a website 1500 according to the principles of the present invention. The process involves a user operating a web browser to communicate with server (e.g., website) construction program 1502. The user may direct commands to the server program to create a new website or other information portal 1504. Following the initiation command, the server program may return a new construction page to the client 1508. Included in the new construction page may be page items, modules, paragraphs, or other construction facilities according to the principles of the present invention. The user may then select a page item template to facilitate the construction of a page item with text and image 1510. The server program may then transmit a corresponding page to the user 1512. The user then continues to build a page and or site according to the method and system described herein and saves the page and/or site 1514.

In an embodiment, the construction facility may be run locally through a computer system. While embodiments of the present invention illustrate the use of a construction facility over a network, the present invention encompasses local and hybrid construction techniques as well. For example, a user may download, or otherwise purchase or procure, construction software and then the information portal could be constructed locally and loaded into a server or other facility to provide the information portal to other users.

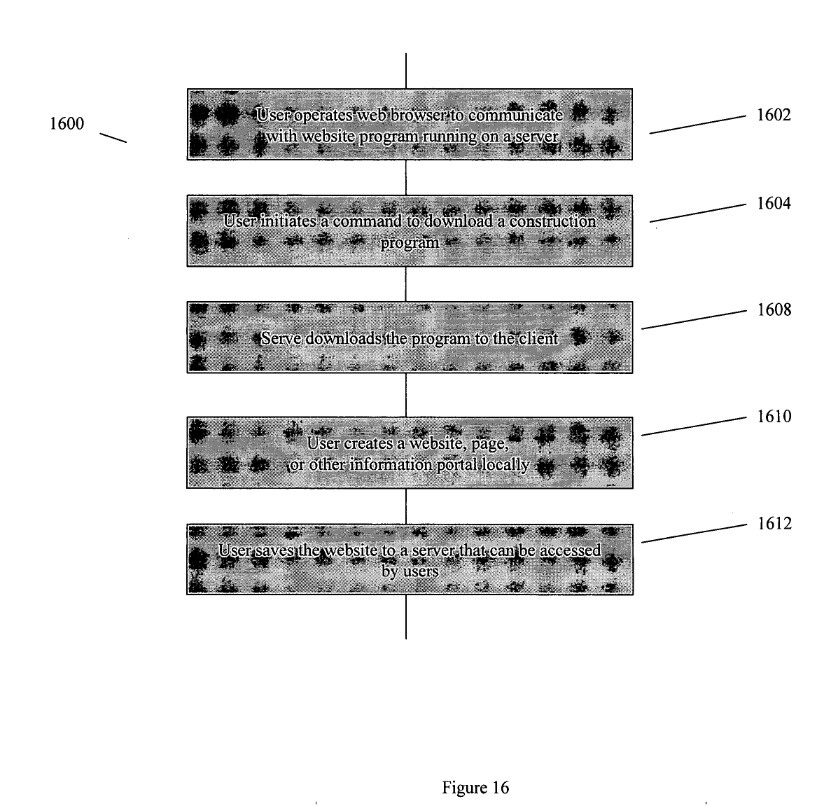

FIG. 16 illustrates a method of developing a website or other information portal locally according to the principles of the present invention 1600. The method involves communicating with a server application through a client application (e.g., browser) 1602. The method also involves the user initiating a command to download a construction program to a local computing facility 1604. The server downloads the construction program to the client 1608. The user may then use the construction program to facilitate the construction of the information portal using the downloaded software 1610. The user may execute the necessary steps to activate the information portal on a server (e.g., in many cases a different server from the one downloading the software) such that the intended users can gain access to the site.

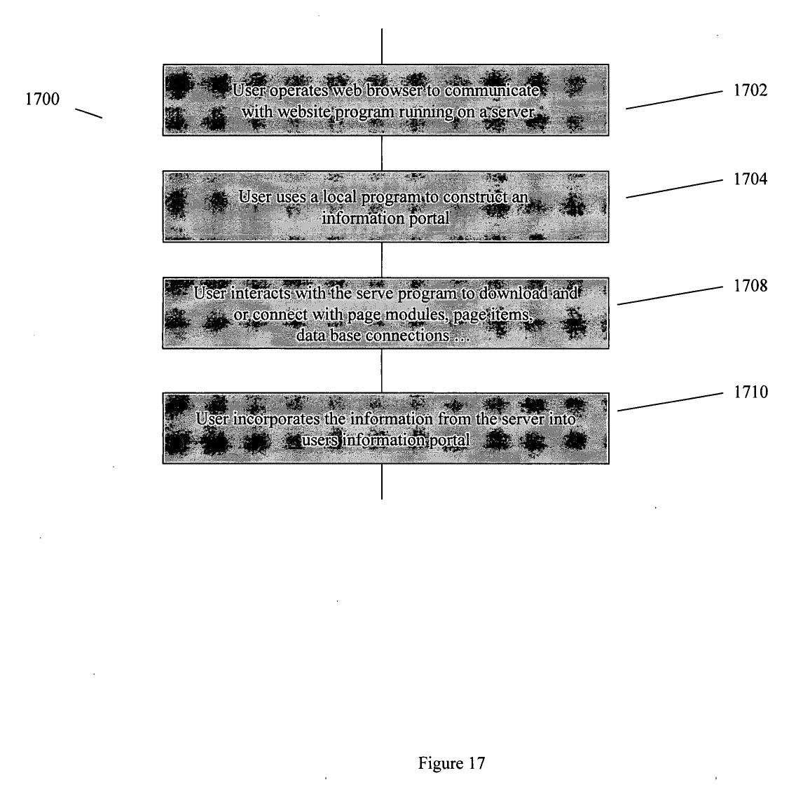

FIG. 17 illustrates a method of developing a website or other information portal locally with server interactions according to the principles of the present invention 1700. The method involves communicating with a server application through a client application (e.g., browser) 1702. The method also involves running an information portal construction program locally 1704. At certain times during the construction, the user may want to interact with a web site construction facility (or other website facility) through the internet and may do so 1708. For example, the user may want a new template, page item, page module, paragraph, or other information or template to assist in the construction of the information portal. The user may also want information, such as a database link, database, image, site mapping feature or other information to integrate or use in the construction of the information portal. The user may then incorporate the link, information, template or the like into the information portal 1710.

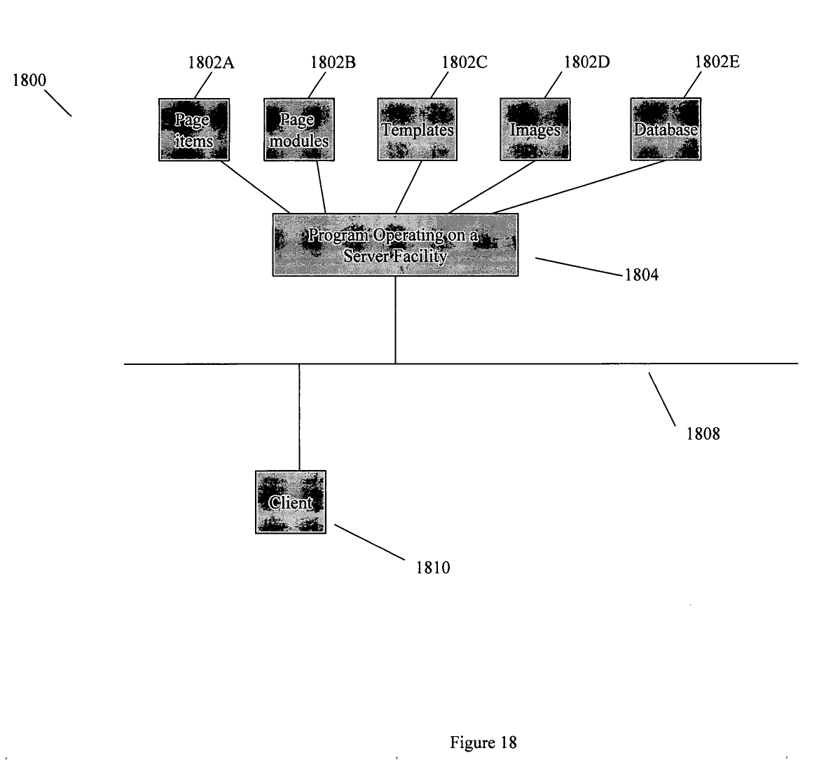

FIG. 18 represents a method and system of developing a website or other information portal locally with server interactions according to the principles of the present invention 1800. Included in the development method and system is a client 1810, a server 1804 and a network communication facility 1808. The program operating on the server provides a client user with access to tools, information, links and other facilities 1802. For example, the server program provides the client access to page items 1802A, page modules 1802B, templates 1802C, images 1802D, databases 1802E and or other facilities to assist in the construction of an information portal.

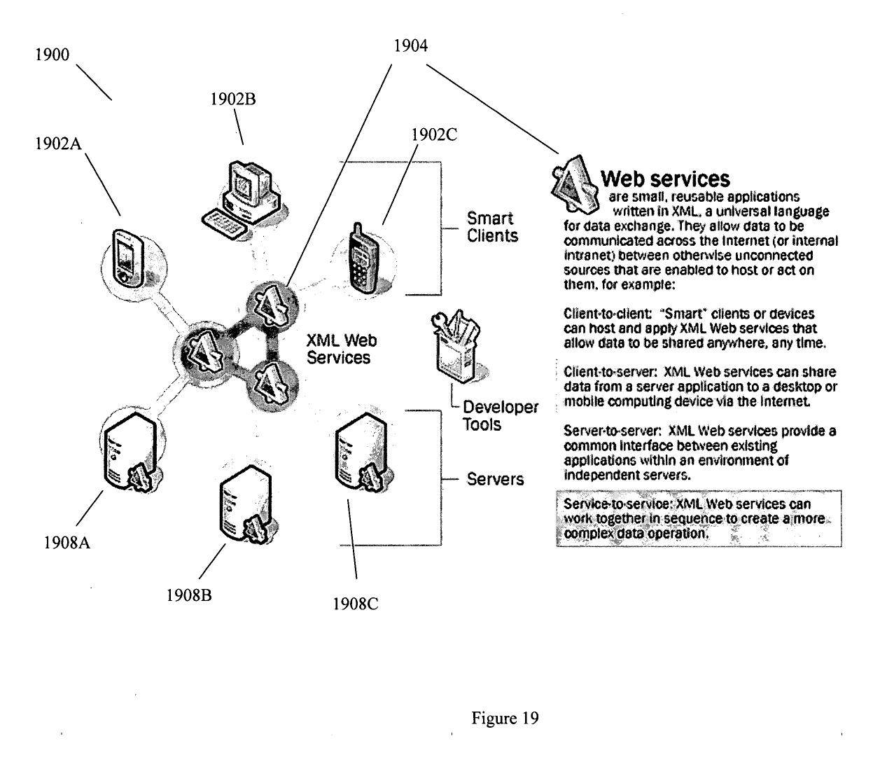

FIG. 19 illustrates an information portal construction facility deployed through XML web services according to the principles of the present invention 1900. The construction facility software may, for example, reside on a server 1908 and a user may design am information portal through provided XML web services 1904 from either another server (e.g. 1908A if the construction facility is offered from 1908B) or a client 1902. For example, the web services may be applications written in XML or other language to facilitate the exchange of information. The web services allow data to be transmitted through a network (e.g., internet, intranet, extranet) between connected or otherwise unconnected computing facilities. For example, several clients 1902 may communicate with one another or with a server through the web services 1904 or several servers 1908 may communicate with one another to facilitate information transfer. Any number of different interactions may take place using web services, such as those provided through Microsoft® Corporation's NET initiatives.

In an embodiment, a user may construct a website, other information portal, or interactions (e.g., links, attachments, ways to communicate) to information portals through the use of XML based web services. For example, a user may use a client such as a PDA, mobile phone, pager, portable web interaction device or other client to construct all or a portion of a website and the interactions and instructions may be facilitated by XML web services. In an embodiment, a user may use a PDA to grab a page building facility (e.g., page module or page item) and construct a web page to be deployed on the user's website. In an embodiment, the user may edit a web page or portion of a web page using page module and item interactions as described herein. For example, a user may use a portable computing device (e.g., a PDA, cell phone, or web enabled device) to search a website. The user may have administrator-type permission and receive access to most all of the pages in the site searched. Once the user finds the page(s) or portions of interest, the user can edit, move, copy, delete, generate new material or otherwise manipulate the page as described herein. The user may select a text box, for example, and edit the text, add an image (e.g., captured through another web search or stored locally) and then save the page. The saved page would then be made available to the users with appropriate permission. This may be a useful technique for an administrator or user of an intranet site for example. The user may be a field user and wants to update some information on an intranet, so the user accomplishes the editing, adding, or the like through the user's portable computing facility enabled through web servicing techniques.

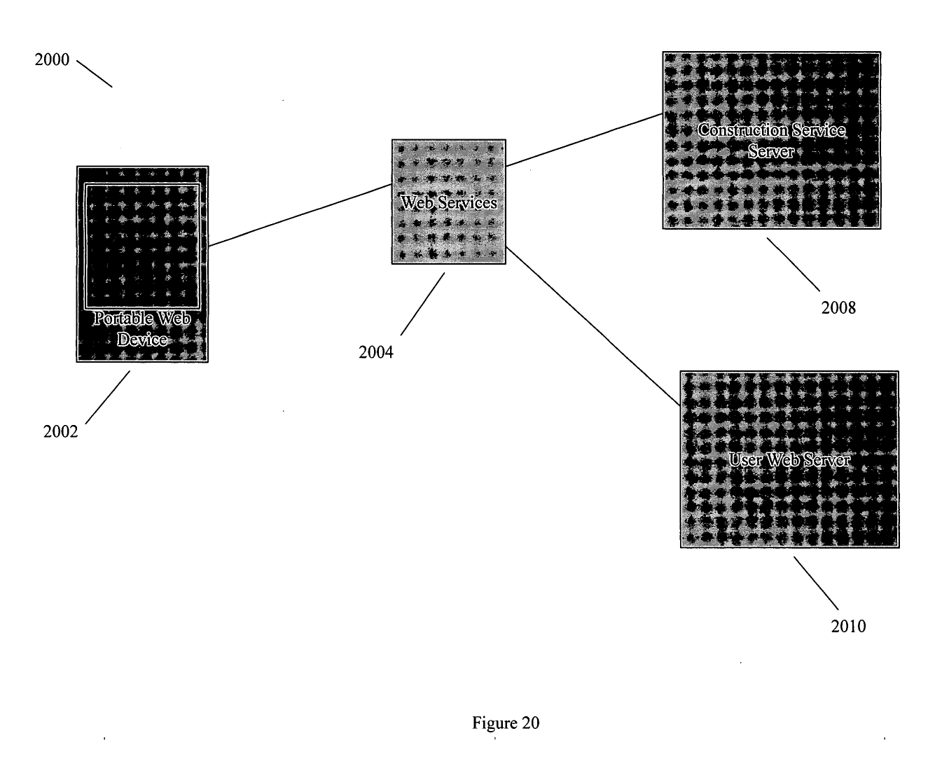

FIG. 20 illustrates a method and system of constructing a website or other information portal through the use of a portable computing device and web services according to the principles of the present invention 2000. The method and system may involve a portable computing device (e.g., pda, cell phone, web viewer, web device) 2002 and a construction service server 2008. The portable computing device may communicate to the construction server 2008 through web services (e.g., XML based or other languages used to facilitate such communication) to obtain certain construction templates, page items, page modules, or other construction facilities as described herein. The user may then use the portable computing device 2002 to generate a page item, page or other information facility. The user may then communicate the new or modified page to the user web server 2010 running the users website and modify the website with the new information. The web services topology illustrated herein is simplified for illustration purposes and it should be understood that a method or system according to the principles of the present invention is not limited by any one particular topology and encompasses different and or more complicated topologies.

Having thus described several illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present invention to accomplish the same or different objectives. In particular, acts, elements, and features discussed in connection with one embodiment are not intended to be excluded from similar or other roles in other embodiments. Accordingly, the foregoing description and attached drawings are by way of example only, and are not intended to be limiting.

1. A web page construction method, comprising:
providing a page item template via a server computer facility;
accessing the page item template via a client computer facility;
building a page item using the page item template via the client computer facility; and
saving the page item to a web page.

2. The web page construction method of claim 1, wherein the page item template comprises a text with image template.

3. The web page construction method of claim 1, wherein the page item template comprises a text editor.

4. The web page construction method of claim 3, wherein the text editor uses a standard word processing facility.

5. The web page construction method of claim 4, wherein the standard word processing facility is Microsoft® Internet Explorer.

6. The web page construction method of claim 1, wherein the page item template includes at least one of a calendar facility, calculator facility, text editor, image facility, link facility, hyperlink facility, spreadsheet facility, and presentation facility.

7. The web page construction method of claim 1, wherein the page item template includes skin application facility.

8-40. (canceled)

41. A web page construction system, comprising:
a page item template facility produced by a server computer facility;
a client computer facility; wherein a user can build a page item using the page item template via the client computer facility; and
a facility to allow the user to save the page item to a web page.

42. The web page construction system of claim 41, wherein the page item template comprises a text with image template.

43. The web page construction system of claim 41, wherein the page item template comprises a text editor.

44. The web page construction system of claim 43, wherein the text editor uses a standard word processing facility.

45. The web page construction system of claim 44, wherein the standard word processing facility is Microsoft® Internet Explorer.

46. The web page construction system of claim 41, wherein the page item template includes at least one of a calendar facility, calculator facility, text editor, image facility, link facility, hyperlink facility, spreadsheet facility, and presentation facility.

47. The web page construction system of claim 41, wherein the page item template includes skin application facility.

48-96. (canceled)
